(19) United States
(12) Patent Application Publication
(10) Pub. No.: US 2026/0369068 A1
(43) Pub. Date: Nov. 19, 2026

(54) MONITORING SYSTEM, INFORMATION PROCESSING DEVICE, METHOD, AND NON-TRANSITORY COMPUTER RECORDING MEDIUM

(71) Applicant: NEC Corporation, Tokyo (JP)

(72) Inventor: Yoshihiro MISHIMA, Tokyo (JP)

(73) Assignee: NEC Corporation, Tokyo (JP)

(21) Appl. No.: 19/143,049

(22) PCT Filed: Jan. 12, 2023
(86) PCT No.: PCT/JP2023/000593

§ 371 Date: Jun. 25, 2025

(51) Int. Cl. G06V 20/54; G06V 20/40

(52) U.S. Cl. CPC G06V 20/54; G06V 20/44

(57) ABSTRACT

This monitoring system includes at least one memory storing instructions and at least one processor. The at least one processor executes: a caution-required state detection process that detects a caution-required state, which is a state in which a surveillants needs to be cautious, on the basis of information indicating the state around a vehicle and/or inside the vehicle; a level estimation process that estimates the level of the detected caution-required state on the basis of levels indicating stages of the caution-required state and associated respectively with a plurality of caution-required states; and a surveillants determination process that determines, as a surveillants corresponding to the detected caution-required state, a surveillants who has an ability corresponding to the estimated level of the caution-required state, on the basis of the correspondence relationship between the caution-required state level and the ability of one or more surveillants.

### TECHNICAL FIELD

The present disclosure relates to a monitoring system, an information processing device, a method, and a program for a surveillants to monitor a vehicle to be monitored.

### BACKGROUND ART

Conventionally, various techniques have been proposed for a surveillants to monitor a vehicle to be monitored. As an example of such a technique, an information processing method disclosed in PTL 1 acquires first information relating to monitoring by a first surveillant to whom monitoring for a first vehicle is assigned, acquires second information relating to monitoring for a second vehicle whose monitoring is not assigned to a surveillants, compares the first information with the second information, generates presentation information indicating monitoring for the second vehicle according to a result of the comparison, and presents the generated presentation information via a presentation device.

### CITATION LIST

### Patent Literature

PTL 1: JP 2020-060841 A

### SUMMARY OF INVENTION

### Technical Problem

However, the information processing method disclosed in PTL 1 addresses a problem of reducing the monitoring load of the surveillant, and thus has a problem that an appropriate surveillant cannot be determined according to the difficulty degree of a state requiring caution.

In view of the problems described above, an object of the present disclosure is to provide a monitoring system, an information processing device, a method, and a non-transitory computer recording medium recorded with a program capable of determining an appropriate surveillant according to the difficulty degree of a state requiring caution.

### Solution to Problem

A monitoring system for one or more surveillants to monitor one or more vehicles according to one illustrative example embodiment, the monitoring system including
a caution-required state detection means for detecting a caution-required state, that is a state requiring caution by the surveillant, based on information indicating a state of at least one of around the vehicle and inside the vehicle,
a level estimation means for estimating a level of the detected caution-required state based on a level indicating a stage of a caution-required state associated with each of a plurality of caution-required states, and
a surveillants determination means for determining, as a surveillants corresponding to the detected caution-required state, a surveillants having an ability corresponding to the estimated level of the caution-required state, based on a correspondence relationship between the level of the caution-required state and an ability of the one or more surveillants.

An information processing device for one or more surveillants to monitor one or more vehicles according to one illustrative example embodiment, the information processing device including
a caution-required state detection means for detecting a caution-required state, that is a state requiring caution by the surveillant, based on information indicating a state of at least one of around the vehicle and inside the vehicle,
a level estimation means for estimating the level of the detected caution-required state based on a level indicating a stage of the caution-required state associated with each of a plurality of caution-required states, and
a surveillants determination means for determining, as a surveillants corresponding to the detected caution-required state, a surveillants having an ability corresponding to the estimated level of the caution-required state, based on a correspondence relationship between the level of caution-required state and the ability of the one or more surveillants.

A method for one or more surveillants to monitor one or more vehicles according to one illustrative example embodiment, in which a computer is configured to
detect a caution-required state, that is a state requiring caution by the surveillant, based on information indicating a state of at least one of around the vehicle and inside the vehicle,
estimate the level of the detected caution-required state based on a level indicating a stage of the caution-required state associated with each of a plurality of caution-required states, and
determine, as a surveillants corresponding to the detected caution-required state, a surveillants having an ability corresponding to the estimated level of the caution-required state, based on a correspondence relationship between the level of caution-required state and the ability of the one or more surveillants.

A non-transitory computer recording medium recorded with a program for one or more surveillants to monitor one or more vehicles according to one illustrative example embodiment, in which when executed, the program causes a computer to
detect a caution-required state, that is a state requiring caution by the surveillant, based on information indicating a state of at least one of around the vehicle and inside the vehicle,
estimate the level of the detected caution-required state based on a level indicating a stage of the caution-required state associated with each of a plurality of caution-required states, and
determine, as a surveillants corresponding to the detected caution-required state, a surveillants having an ability corresponding to the estimated level of the caution-required state, based on a correspondence relationship between the level of caution-required state and the ability of the one or more surveillants.

### Advantageous Effects of Invention

According to the present disclosure, a monitoring system, an information processing device, a method, and a program capable of determining an appropriate surveillant according to the difficulty degree of a state requiring caution can be provided.

### BRIEF DESCRIPTION OF DRAWINGS

FIG. 1 is a diagram illustrating a monitoring system according to one illustrative example embodiment.

FIG. 2 is a diagram illustrating a configuration of a management device according to one illustrative example embodiment.

FIG. 3 is a diagram illustrating an example of a database that defines a correspondence relationship between a caution-required state and a level of caution-required state.

FIG. 4 is a diagram illustrating an example of a data table that defines a correspondence relationship between the level of caution-required state and abilities of one or more surveillants.

FIG. 5 is a diagram illustrating an example of a data table in which information relating to a surveillants is registered.

FIG. 6 is a sequence diagram illustrating an example of a process executed in the monitoring system according to the one illustrative example embodiment.

FIG. 7 is a diagram illustrating main components of the monitoring system according to the one illustrative example embodiment.

FIG. 8 is a diagram illustrating an example of a data table in which a level of a detected caution-required state and a history of position information associated with the caution-required state are registered.

FIG. 9 is a diagram illustrating an example of a data table that defines a correspondence relationship between the caution-required state and a process executed by a vehicle.

FIG. 10 is a diagram illustrating another example of a data table in which information relating to the surveillant is registered.

FIG. 11 is a diagram illustrating another example of a data table in which information relating to the surveillant is registered.

### EXAMPLE EMBODIMENT

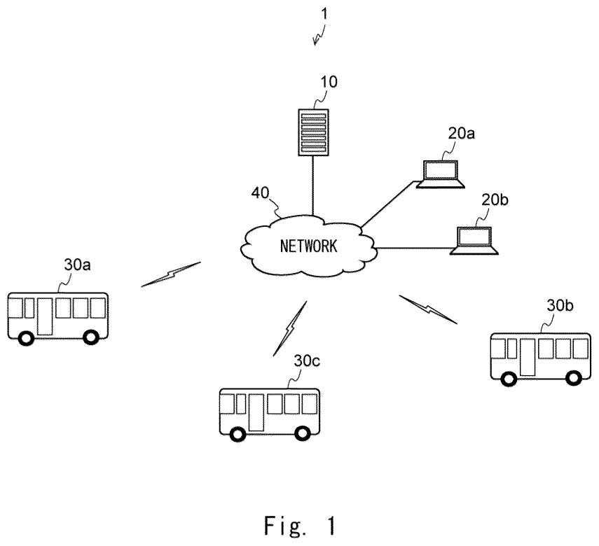

Hereinafter, illustrative example embodiments will be described with reference to the drawings. FIG. 1 is a diagram illustrating an example of a monitoring system 1 for one or more surveillants to monitor one or more vehicles. The monitoring system 1 includes a management device 10, operation terminals 20a and 20b, and vehicles 30a to 30c. The management device 10 can mutually communicate data with the operation terminals 20a and 20b and the vehicles 30a to 30c via a network 40. In addition, the operation terminals 20a and 20b and the vehicles 30a to 30c can communicate data with each other via the network 40. The network 40 can be constructed by a network device capable of performing wireless communication and/or wired communication. The network 40 can include various networks such as a local area network (LAN) and/or a wide area network (WAN).

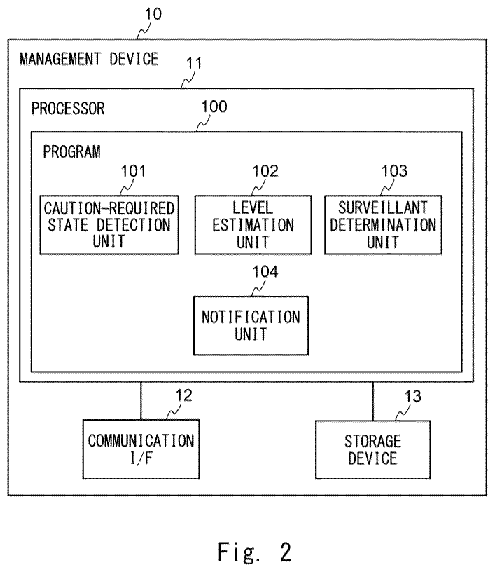

The management device 10 is a device configured to process various types of information relating to monitoring of the vehicles 30a to 30c by the surveillant. Specific examples of the management device 10 include an information processing device such as a personal computer (PC) or a server. The management device 10 corresponds to a computer. The configuration of the management device 10 will be described later with reference to FIG. 2.

The operation terminals 20a and 20b are information processing devices used by the surveillant to monitor and control the vehicles 30a to 30c. Specific examples of the operation terminals 20a and 20b include an information processing device such as a PC and a tablet terminal.

The vehicles 30a to 30c are vehicles to be monitored by the surveillant. Specific examples of the vehicles 30a to 30c include vehicles for carrying passengers such as a route bus and a taxi. In addition, the vehicles 30a to 30c may be vehicles such as passenger cars and trucks. The vehicles 30a to 30c include a photographing device, a vehicle control device, and a communication device. The photographing device photographs a state of at least one of around the vehicles 30a to 30c and inside the vehicles 30a to 30c to generate a photographed image. The photographed image corresponds to information (hereinafter referred to as “state information”) indicating a state of at least one of around the vehicles 30a to 30c and inside the vehicles 30a to 30c. The photographing device transmits the photographed image to the management device 10 via the communication device.

Furthermore, the vehicles 30a to 30c may include various sensors such as a speed sensor, a distance measuring sensor, a temperature sensor, a human sensor, and a steering angle sensor in addition to the photographing device. The speed sensor can measure the speed of the vehicles 30a to 30c. The distance measuring sensor can measure a distance between the vehicles 30a to 30c and another object. The temperature sensor can measure the temperature of at least one of the inside the vehicles 30a to 30c and around the vehicles 30a to 30c. The human sensor can detect the presence or absence of a person in a specific area in the vehicle. The steering angle sensor can measure a steering angle of the steering wheel. The measurement data measured by these sensors corresponds to state information. These sensors transmit the measurement data to the management device 10 via the communication device. Furthermore, the vehicles 30a to 30c can include a communication device configured to receive a signal from an external device. The communication device can receive positioning signals indicating the positions of the vehicles 30a to 30c from a positioning satellite. Furthermore, the communication device can receive congestion information of a road on which the vehicles 30a to 30c are traveling, lane restriction information, obstacle information, information relating to construction, and the like. The positioning signal, the congestion information of the road, the lane restriction information, the obstacle information, and the information relating to construction correspond to state information.

Furthermore, the vehicle control device executes a process based on the control information received from the management device 10.

FIG. 2 is a diagram illustrating a configuration of the management device 10 according to one illustrative example embodiment. The management device 10 includes a processor 11 capable of executing various programs, a communication interface (I/F) 12, and a storage device 13. Specific examples of the processor 11 include various processors such as a central processing unit (CPU) and a micro processing unit (MPU).

The management device 10 performs data communication with another device via the communication interface 12. The storage device 13 stores various information such as a program 100 executed by the processor 11 and a database.

The processor 11 executes a method according to the one illustrative example embodiment by reading a program 100 from the storage device 13 and executing the program. The program 100 includes a caution-required state detection unit 101, a level estimation unit 102, a surveillants determination unit 103, and a notification unit 104. The functions of the program 100 may be implemented by an integrated circuit such as a field-programmable gate array (FPGA) or an application specific integrated circuit (ASIC). An integrated circuit such as a processor, an FPGA, and an ASIC corresponds to a computer. An integrated circuit such as a processor, an FPGA, and an ASIC corresponds to a computer.

The caution-required state detection unit 101 is a program that detects the caution-required state based on the state information provided by the vehicles 30a to 30c. For example, when receiving a photographed image as the state information from the vehicles 30a to 30c, the caution-required state detection unit 101 is a program that analyzes the photographed image and determines whether the photographed image includes the caution-required state. In the photographed image, a state of at least one of around the vehicles 30a to 30c and inside the vehicles 30a to 30c is photographed. The caution-required state is a state in which the surveillant needs to be cautious. The caution-required state includes a state of around the vehicles 30a to 30c and a state of a person riding on the vehicles 30a to 30c.

For example, specific examples of the caution-required state regarding the exterior of the vehicle include a situation in which a pedestrian or an obstacle is present on a road on which the vehicles 30a to 30c travel, a situation in which a stopped vehicle or a parked vehicle is present in front of the vehicles 30a to 30c, a situation in which the front of the vehicles 30a to 30c is congested, a situation in which the width of the road on which the vehicles 30a to 30c are scheduled to travel is narrower than the vehicle width of the own vehicle, a situation in which a pedestrian is walking on a side road, a time at which the vehicles 30a to 30c pass a pedestrian crossing and a time at which the vehicles pass an intersection, a time at which the vehicles 30a to 30c turn right or left, and a case in which the road on which the vehicles 30a to 30c travel is under construction.

In addition, the caution-required state regarding the inside of the vehicle includes a state caused by a passenger, a state caused by a driver, and the like. Specific examples of the state caused by the passenger include a case where the passenger is collapsed, a case where the passenger is crouching, a case where the passenger is moving in the vehicle while the vehicles 30a to 30c are traveling, and a case where the passenger is near the door at the time of opening/closing the passenger door. Specific examples of the state caused by the driver include a case where the driver is dozing, a case where the driver is lying on his/her face, a case where the driver is leaning back, and a case where the driver is performing “distracted driving”. The “distracted driving” includes smoking, talking, equipment operation, and the like during driving.

The caution-required state detection unit 101 can detect the caution-required state by executing pattern matching process on a reference image and the photographed image indicating the caution-required state.

Furthermore, the caution-required state detection unit 101 can detect the caution-required state by using a trained model trained by machine learning. In this case, the model can perform learning by using training data in which the photographed image indicating the caution-required state is used as input information and the information indicating that the state is the caution-required state is used as the output information. When the photographed image indicating the caution-required state is input, the trained model trained using the training data outputs information indicating that the state is the caution-required state. The caution-required state detection unit 101 can detect the pose and action of the passenger and the driver described above by using the trained model. In addition, the caution-required state detection unit 101 can detect the action of the pedestrian described above by using the trained model. Furthermore, the caution-required state detection unit 101 can detect a stopped vehicle and a parked vehicle present in front of the vehicles 30a to 30c and a congestion in front of the vehicles 30a to 30c by using the trained model. Moreover, the caution-required state detection unit 101 can detect a pedestrian on a road on which the vehicles 30a to 30c travel or on a side road of the road by using the trained model. Moreover, the caution-required state detection unit 101 can detect an obstacle on a road on which the vehicles 30a to 30c travel by using the trained model.

Furthermore, the caution-required state detection unit 101 can detect a stopped vehicle or a parked vehicle ahead present within a predetermined distance based on detection information of the distance measuring sensor. Furthermore, the caution-required state detection unit 101 can detect a congestion of a road on which the vehicles 30a to 30c travel by using information on the current positions of the vehicles 30a to 30c and congestion information received by the communication device. Furthermore, the caution-required state detection unit 101 can detect construction of a road on which the vehicles 30a to 30c travel by using information on the current positions of the vehicles 30a to 30c and position information received by the communication device. The caution-required state detection unit 101 can detect an obstacle on a road on which the vehicles 30a to 30c travel by using information on the current positions of the vehicles 30a to 30c and position information of the obstacle received by the communication device. Furthermore, the caution-required state detection unit 101 can detect the passing through the pedestrian crossing and the passing through the intersection of the vehicles 30a to 30c based on the information on the current positions of vehicles 30a to 30c and the position information of the pedestrian crossing and the position information of the intersection received by the communication device.

Furthermore, the caution-required state detection unit 101 can detect right turn and left turn of the vehicles 30a to 30c based on the steering angle of the steering wheel detected by the steering angle sensor of the vehicles 30a to 30c. Moreover, the caution-required state detection unit 101 can detect a passenger in a predetermined area inside the vehicle, for example, a dangerous area inside the vehicle based on detection information of human sensors installed in the vehicles 30a to 30c.

Furthermore, the caution-required state detection unit 101 can detect, as the caution-required state, a situation in which the width of the road on which the vehicles 30a to 30c are scheduled to travel is narrower than the vehicle width of the own vehicle. In this case, the caution-required state detection unit 101 identifies travelable areas that are areas where the vehicles 30a to 30c can travel. More specifically, the caution-required state detection unit 101 detects a road area included in the photographed image by using the photographed images of around the vehicles 30a to 30c. The caution-required state detection unit 101 can detect the road area by using a trained model trained by machine learning based on various object recognition methods such as, for example, objectness, constrained parametric min-cuts (CPMC), selective search, and object proposals. In the detection of the road area, map information, for example, information of a known road width, information of a road line, or the like may be supplementarily used.

Next, the caution-required state detection unit 101 determines whether traffic participants such as pedestrians, bicycles, and automobiles are present in the detected road area. The caution-required state detection unit 101 can detect the traffic participant by using a trained model trained by machine learning based on the various object recognition methods described above.

Next, the caution-required state detection unit 101 specifies an area where no traffic participant is present in the detected road area as a travelable area. The travelable area is obtained by deleting the image region of the traffic participant from the image region of the detected road area.

Next, the caution-required state detection unit 101 calculates the width of the travelable area located in the destination direction of the vehicles 30a to 30c. The travelable area located in the destination direction of the vehicles 30a to 30c can be specified, for example, by detecting a road area and a traffic participant using a photographed image obtained by photographing the front side of the vehicles 30a to 30c. The caution-required state detection unit 101 can calculate the width of the travelable area based on the coordinate distances of both end portions of the travelable area in the horizontal direction within the photographed image. Specifically, the caution-required state detection unit 101 specifies coordinates of both end portions of the travelable area in the horizontal direction within the photographed image, and calculates a distance of these coordinates.

Next, the caution-required state detection unit 101 can calculate the width of the travelable area by multiplying the calculated distance of the coordinates by a predetermined correction value. The predetermined correction value can be defined based on the distance of the coordinates within the photographed image and the actual distance.

Then, the caution-required state detection unit 101 determines whether the calculated width of the travelable area is less than the vehicle width of the vehicles 30a to 30c. When the width of the travelable area is less than the vehicle width of the vehicles 30a to 30c, the caution-required state detection unit 101 detects the state of the vehicle as the caution-required state. In this manner, the caution-required state detection unit 101 can detect, as the caution-required state, a situation in which the vehicle width through which the vehicles 30a to 30c pass cannot be secured due to the presence of a traffic participant such as a vehicle waiting to make a right turn in front of the vehicles 30a to 30c.

In another example embodiment, the caution-required state detection unit 101 may develop the specified travelable area in a bird's eye view, and determine whether the width of the travelable area located in the destination direction of the vehicles 30a to 30c is less than the vehicle width of the vehicles 30a to 30c.

In addition, the caution-required state detection unit 101 can detect the caution-required state by using the machine-trained learning model. This learning model can be trained by using training data having a photographed image in which the caution-required state is photographed as an input and information indicating that the state is the caution-required state as an output. As a result, when the photographed image in which the caution-required state is photographed is input, the caution-required state detection unit 101 can output information indicating that the state is the caution-required state.

Furthermore, this learning model can be trained by using training data having measurement data corresponding to the caution-required state as an input and information indicating that the state is the caution-required state as an output. As a result, when the measurement data corresponding to the caution-required state is input, the caution-required state detection unit 101 can output information indicating that the state is the caution-required state.

The level estimation unit 102 is a program that estimates a level indicating a stage of the caution-required state detected by the caution-required state detection unit 101. The level indicating the stage of the attention-requiring state is, for example, a level indicating the difficulty degree of the caution-required state corresponding to the surveillant. In addition, the level indicating the stage of the caution-required state may be a level indicating the importance degree or the urgency degree of the caution-required state. Hereinafter, the level indicating the stage of the caution-required state is simply referred to as “level of caution-required state”. The level of caution-required state includes a level at which the surveillant does not require driving control of the vehicles 30a to 30c by a remote operation and a level at which the surveillant requires driving control of the vehicles 30a to 30c by a remote operation.

At a level (level 1) at which the surveillant does not require driving control of the vehicles 30a to 30c, the surveillant can cause the vehicles 30a to 30c to execute a process of calling attention to a person riding on the vehicles 30a to 30c. For example, the process of calling attention is a process of reproducing a voice for calling attention such as “coming to stop”, “making right turn”, or “do not move during traveling”.

The level at which the surveillant requires driving control of the vehicles 30a to 30c includes a level (level 2) at which remote control is required for some of the driving tasks in the vehicles 30a to 30c and a level (level 3) at which remote control is required for all the driving tasks in the vehicles 30a to 30c. The driving task is an operation performed on the vehicles 30a to 30c by the driver. For example, the driving task includes operations of devices included in the vehicles 30a to 30c, for example, an accelerator, a brake, a steering wheel, a blinker, a hazard lamp, a light, a honk, a display device, and the like.

The remote control related to the level 2 driving task includes, for example, control of a device related to stop of traveling of the vehicle, control of a device related to deceleration of the speed of the vehicle, control of a device related to start of traveling of the vehicle, predetermined control process, and the like. The predetermined control process includes a brake operation for collision prevention. The surveillant can cause the vehicles 30a to 30c corresponding to the level 2 caution-required state to execute these control processes.

At level 3, the surveillant can execute remote control of all the driving tasks in the vehicles 30a to 30c. In other words, the surveillant can perform driving intervention including steering wheel operation, blinker operation, and the like in addition to accelerator operation and brake operation of the vehicles 30a to 30c.

The level estimation unit 102 estimates a level corresponding to the detected caution-required state based on the level of caution-required state associated with each of such caution-required states. FIG. 3 illustrates an example of a data table that defines a correspondence relationship between the caution-required state and the level of caution-required state. The level estimation unit 102 refers to such a data table and determines a level corresponding to the detected caution-required state.

Furthermore, the level estimation unit 102 can estimate the level of caution-required state by using the machine trained learning model. This learning model can be trained by using training data having a photographed image in which the caution-required state is photographed as an input and information indicating the level of caution-required state as an output. As a result, when the photographed image in which the caution-required state is photographed is input, the caution-required state detection unit 101 can output information indicating the level of caution-required state.

The surveillant determination unit 103 is a program that determines a surveillants corresponding to the detected caution-required state based on the level of caution-required state estimated by the level estimation unit 102 and the ability of the surveillant. More specifically, the surveillant determination unit 103 determines the surveillant having the ability corresponding to the estimated level of caution-required state based on the correspondence relationship between the level of caution-required state and the abilities of one or more surveillants.

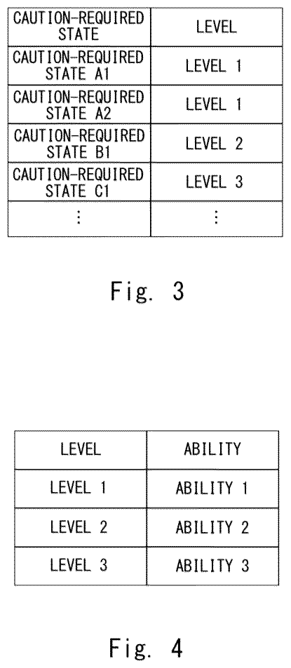

FIG. 4 is a diagram illustrating an example of a data table that defines a correspondence relationship between the level of caution-required state and abilities of one or more surveillants. The surveillant determination unit 103 refers to such a data table and determines the ability corresponding to the determined level.

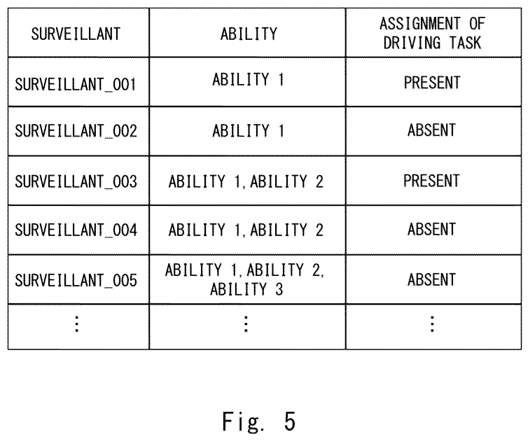

FIG. 5 is a diagram illustrating an example of a data table in which information relating to a surveillants is registered. In the data table illustrated in FIG. 5, identification information of a surveillants, ability of the surveillant, and presence or absence of assignment of a driving task to the surveillant are registered in association with each other. The surveillant determination unit 103 refers to such a data table and determines a surveillants corresponding to the determined ability from among surveillants to whom no driving task is assigned as a surveillants corresponding to the detected caution-required state.

More specifically, for example, in a case where a level (level 1) of low difficulty degree is estimated as the level of caution-required state, the surveillant determination unit 103 can preferentially determine a surveillants having only the ability corresponding to the level (level 1) of low difficulty degree as the surveillant corresponding to the caution-required state from among the surveillants to whom no driving task is assigned.

The notification unit 104 is a program that notifies notification information including a determination result by the surveillant determination unit 103. The notification information includes identification information of the surveillant and identification information of the vehicle to be monitored. The notification unit 104 specifies the operation terminals 20a and 20b associated with the determined surveillant, and transmits notification information to the operation terminals. The storage device 13 saves information in which the identification information of the surveillant and the identification information of the operation terminals 20a and 20b are associated with each other. The notification unit 104 can specify the operation terminals 20a and 20b corresponding to the determined surveillant based on this information.

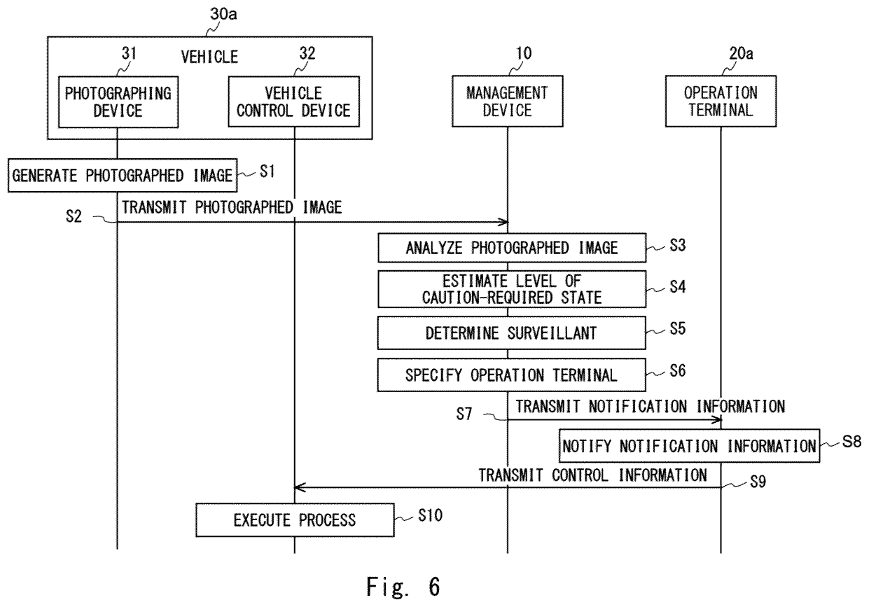

FIG. 6 is a sequence diagram illustrating an example of a process executed in the monitoring system 1. In step S1, the photographing device 31 of the vehicle 30a generates a photographed image of at least one of around the vehicle 30a and inside the vehicle 30a. In step S2, the photographing device 31 transmits the generated photographed image to the management device 10.

When the management device 10 receives the photographed image from the photographing device 31, in step S3, the caution-required state detection unit 101 of the management device 10 analyzes the photographed image transmitted by the photographing device 31 and determines whether the photographed image includes the caution-required state. In a case where the photographed image includes the caution-required state, the level estimation unit 102 of the management device 10 estimates the level of the detected caution-required state in step S4. In step S5, the surveillant determination unit 103 of the management device 10 determines the surveillant having the ability corresponding to the detected caution-required state based on the estimated level of caution-required state and the ability of the surveillant.

In step S6, the notification unit 104 of the management device 10 specifies the operation terminal associated with the determined surveillant. In the example of FIG. 4, it is assumed that the operation terminal 20a is specified. In step S7, the notification unit 104 transmits notification information including a determination result by the surveillant determination unit 103 to the specified operation terminal 20a.

When receiving the notification information from the management device 10, the operation terminal 20a notifies the determined surveillant of the notification information in step S8. In step S9, the operation terminal 20a transmits control information for controlling the vehicle 30a to be monitored of the surveillant to the vehicle control device 32 of the vehicle 30a based on the control of the surveillant.

When receiving the control information from the management device 10, the vehicle control device 32 of the vehicle 30a executes a process based on the control information.

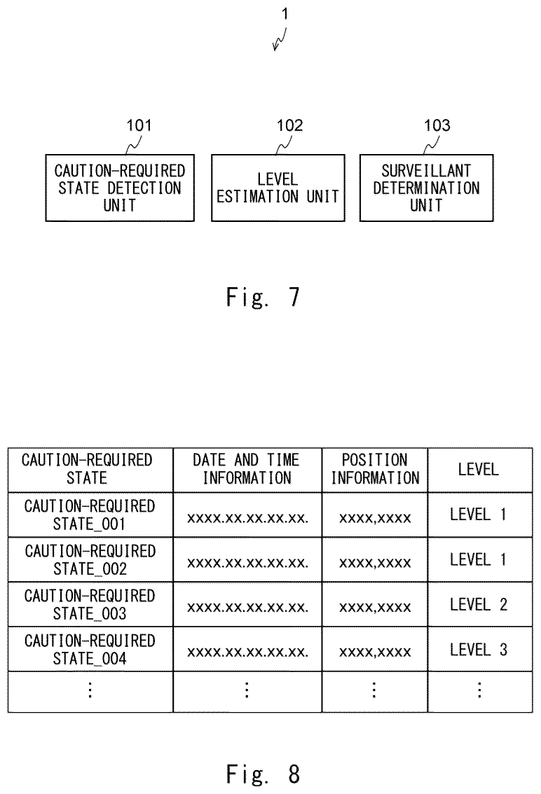

FIG. 7 is a diagram illustrating main components included in the monitoring system 1. The monitoring system 1 includes a caution-required state detection unit 101, a level estimation unit 102, and a surveillants determination unit 103. The caution-required state detection unit 101 detects a caution-required state that is a state requiring caution of the surveillant, based on information indicating the state of at least one of around the vehicle and inside the vehicle. The level estimation unit 102 estimates the level of the detected caution-required state based on the level of caution-required state associated with each of the plurality of caution-required states. More specifically, the surveillant determination unit 103 determines the surveillant having the ability corresponding to the estimated level of caution-required state based on the correspondence relationship between the level of caution-required state and the abilities of one or more surveillants.

By adopting this configuration, a surveillants having an ability corresponding to the level of difficulty degree of the estimated caution-required state can be determined, and hence a surveillants who can handle the detected caution-required state can be determined. As a result, an appropriate surveillant corresponding to the level of difficulty degree of the caution-required state can be determined. In other words, an event in which a surveillants who cannot handle the detected caution-required state monitors the caution-required state can be prevented.

In another example embodiment, the level estimation unit 102 can further estimate the level of caution-required state to be estimated based history information representing a correspondence relationship between the level of caution-required state detected in the past and the position information associated with the caution-required state, and the position information associated with the caution-required state to be estimated. FIG. 8 is a diagram illustrating an example of a data table in which the history information is registered. More specifically, the level estimation unit 102 determines whether the position information of the caution-required state of the level estimation target matches the position information of the caution-required state detected in the past. In a case where these pieces of position information match, the level estimation unit 102 can determine the level of caution-required state detected in the past in which determination is made that the position information matches the position information of the caution-required state to be estimated as the level of caution-required state to be estimated.

For example, in a case where the level 3 caution-required state has already been detected based on the photographed image of around the vehicle traveling in a place where a traffic accident is likely to occur, such as a stop, a place where a lane restriction is applied, or a place where a congestion occurs, the level estimation unit 102 determines the level of caution-required state detected based on the photographed images photographed in these places as level 3. Then, the management of the vehicles 30a to 30c corresponding to the level 3 caution-required state can be assigned to the surveillant having high ability to respond to the level 3 caution-required state. In other words, a surveillants having high ability can manage the vehicles 30a to 30c traveling in a place where a traffic accident is likely to occur.

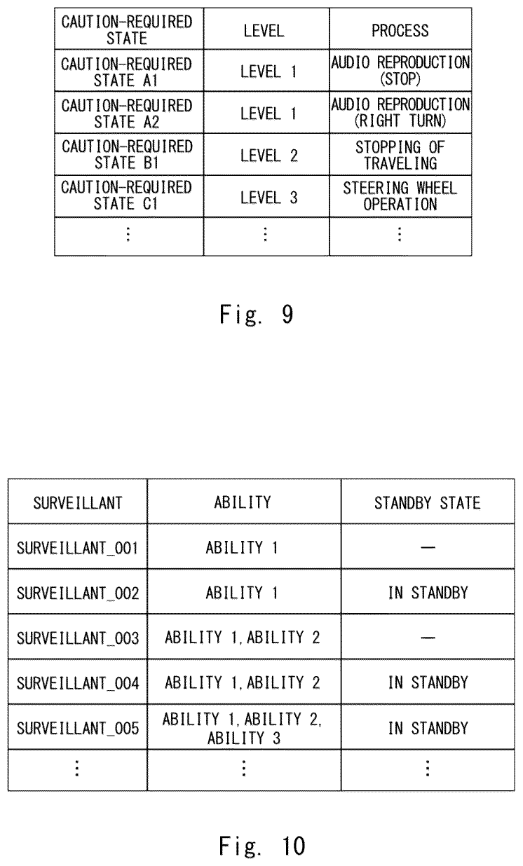

Furthermore, in another example embodiment, the management device 10 can further include a process determination unit for determining a process to be executed by the vehicle associated with the detected caution-required state based on the caution-required state and the process to be executed by the vehicle. FIG. 9 is a diagram illustrating an example of a data table that defines a correspondence relationship between a caution-required state and a process executed by a vehicle. Specifically, when a caution-required state identified in a caution-required state Al is detected, the process determination unit can determine a process of reproducing a voice indicating that the vehicle stops as the process executed by the vehicle associated with the caution-required state. In this case, in addition to the identification information of the surveillant and the identification information of the vehicle to be monitored, the notification unit 104 transmits, as the notification information, identification information of the process the surveillant causes the vehicles 30a to 30c to execute to the operation terminals 20a and 20b. The operation terminals 20a and 20b notify the surveillant of the notification information. As a result, the surveillant can grasp the process the surveillant causes the operation terminals 20a and 20b to execute.

In another example embodiment, the surveillant who performs the driving task may be selected from the surveillants who are waiting to be assigned with the driving task. In this case, in the data table in which the information relating to the surveillant is registered, as illustrated in FIG. 10, information indicating whether on standby is registered in association with the identification information of the surveillant. The surveillant determination unit 103 refers to a data table as illustrated in FIG. 10 and determines a surveillants corresponding to the detected caution-required state from among surveillants waiting for a driving task. In other words, the surveillant determination unit 103 can determine the surveillant corresponding to the detected caution-required state from among the surveillants waiting for the driving task based on the surveillant and the standby state of the driving task of the surveillant.

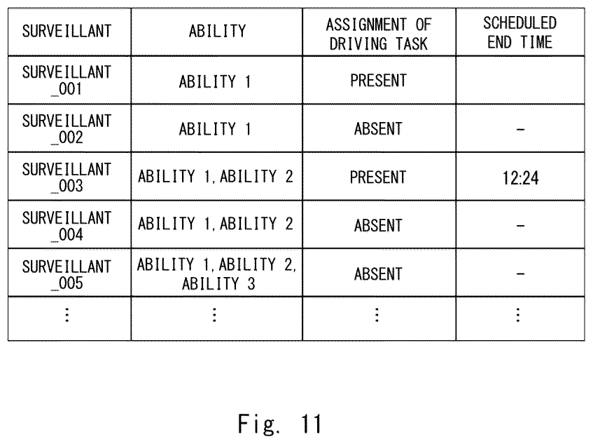

Furthermore, in another example embodiment, not only the surveillant to whom the driving task is not assigned but also the surveillant who performs the driving task may be selected from the surveillants whose scheduled end time at which the driving task is scheduled to end is close. In this case, in the data table in which the information relating to the surveillant is registered, as illustrated in FIG. 11, the scheduled end time of the driving task assigned to the surveillant is registered in association with the identification information of the surveillant. The surveillant determination unit 103 refers to the data table as illustrated in FIG. 11 and determines a surveillants whose difference time between the scheduled end time of the driving task and the current time is within a predetermined time as a surveillants corresponding to the detected caution-required state. In other words, the surveillant determination unit 103 can determine, as the surveillant corresponding to the detected caution-required state, the surveillant whose difference time between the scheduled end time of the driving task and the current time is within the predetermined time based on the surveillant to whom the driving task is assigned, the scheduled end time at which the driving task is scheduled to end, and the current time. The predetermined time may be any time. As a result, a driving task can be newly assigned to the surveillant who is about to finish the driving task. Therefore, the surveillant can smoothly perform the next driving task, and the monitoring efficiency of the surveillant can be improved. In addition, the possibility of assigning a more suitable surveillant to the event to be handled can be increased. Furthermore, since the driving tasks of the vehicles 30a to 30c are reserved from the viewpoint of the vehicle side, it can be treated not as a state of waiting for the assignment of the surveillant corresponding to the driving tasks of the vehicles 30a to 30c, but as a state in which the surveillant is preparing. Then, the management device 10 causes the display devices installed in the vehicles 30a to 30c to display that the surveillant of the vehicle is preparing, thereby giving the passenger a sense of security.

In the example described above, the program includes a group of commands (or software codes) for causing a computer to execute one or more functions described in the example embodiments in a case where the program is read by the computer. The program may be stored in a non-transitory computer-readable medium or a tangible storage medium. As an example and not by way of limitation, the computer readable medium or the tangible storage medium includes a random-access memory (RAM), a read-only memory (ROM), a flash memory, a solid-state drive (SSD) or any other memory technology, a CD-ROM, a digital versatile disk (DVD), a Blu-ray (registered trademark) disc or any other optical disk storage, a magnetic cassette, a magnetic tape, a magnetic disk storage, and any other magnetic storage device. The program may be transmitted on a transitory computer-readable medium or a communications medium. Without being limited, but examples of the transitory computer-readable medium or the communication medium include an electric signal, an optical signal, an acoustic signal, or any other form of propagation signal.

The present disclosure is not limited to the example embodiments described above, and can be appropriately changed within a scope not deviating from the gist of the present disclosure.

Some or all the above example embodiments may be described as the following Supplementary Notes, but are not limited to the following.

### Supplementary Note 1

A monitoring system for one or more surveillants to monitor one or more vehicles, the monitoring system including:
a caution-required state detection means for detecting a caution-required state, that is a state requiring caution by the surveillant, based on information indicating a state of at least one of around the vehicle and inside the vehicle,
a level estimation means for estimating a level of the detected caution-required state based on a level indicating a stage of a caution-required state associated with each of a plurality of caution-required states, and
a surveillants determination means for determining, as a surveillants corresponding to the detected caution-required state, a surveillants having an ability corresponding to the estimated level of the caution-required state, based on a correspondence relationship between the level of the caution-required state and an ability of the one or more surveillants.

### Supplementary Note 2

The monitoring system according to supplementary note 1, wherein the level of caution-required state includes a level at which the surveillant does not require a driving control of the vehicle by a remote operation and a level at which the surveillant requires a driving control of the vehicle by a remote operation.

### Supplementary Note 3

The monitoring system according to supplementary note 2, wherein the level requiring the driving control of the vehicle includes a level at which remote control is required for some of the driving tasks in the vehicle and a level at which remote control is required for all the driving tasks in the vehicle.

### Supplementary Note 4

The monitoring system according to any one of supplementary notes 1 to 3, wherein the surveillant determination means further determines a surveillants corresponding to the detected caution-required state from among surveillants to whom the driving task is not assigned, based on the surveillant and presence or absence of a driving task assigned to the surveillant.

### Supplementary Note 5

The monitoring system according to any one of supplementary notes 1 to 3, wherein the surveillant determination means further determines a surveillants corresponding to the detected caution-required state from among surveillants waiting for a driving task, based on the surveillant and a standby state of a driving task of the surveillant.

### Supplementary Note 6

The monitoring system according to supplementary note 5, wherein the surveillant determination means further determines, as the surveillant corresponding to the detected caution-required state, a surveillants whose difference time between a scheduled end time of the driving task and a current time is within a predetermined time based on a surveillants to whom the driving task is assigned, the scheduled end time at which the driving task is scheduled to end, and the current time.

### Supplementary Note 7

The monitoring system according to any one of supplementary notes 1 to 3, wherein the level estimation means further estimates a level of caution-required state to be estimated based on history information representing a correspondence relationship between a level of the caution-required state detected in the past and position information associated with the caution-required state and position information associated with the caution-required state to be estimated.

### Supplementary Note 8

The monitoring system according to any one of supplementary notes 1 to 3, further including:
a process determination means for determining a process to be executed by a vehicle associated with the detected caution-required state based on the caution-required state and the process to be executed by the vehicle, and
a notification unit for notifying information indicating the determined process.

### Supplementary Note 9

An information processing device for one or more surveillants to monitor one or more vehicles, the information processing device including:
a caution-required state detection means for detecting a caution-required state, that is a state requiring caution by the surveillant, based on information indicating a state of at least one of around the vehicle and inside the vehicle,
a level estimation means for estimating the level of the detected caution-required state based on a level indicating a stage of the caution-required state associated with each of a plurality of caution-required states, and
a surveillants determination means for determining, as a surveillants corresponding to the detected caution-required state, a surveillants having an ability corresponding to the estimated level of the caution-required state, based on a correspondence relationship between the level of caution-required state and the ability of the one or more surveillants.

### Supplementary Note 10

A method for one or more surveillants to monitor one or more vehicles, wherein a computer is configured to:
detect a caution-required state, that is a state requiring caution by the surveillant, based on information indicating a state of at least one of around the vehicle and inside the vehicle,
estimate the level of the detected caution-required state based on a level indicating a stage of the caution-required state associated with each of a plurality of caution-required states, and
determine, as a surveillants corresponding to the detected caution-required state, a surveillants having an ability corresponding to the estimated level of the caution-required state, based on a correspondence relationship between the level of caution-required state and the ability of the one or more surveillants.

### Supplementary Note 11

A non-transitory computer recording medium recorded with a program for one or more surveillants to monitor one or more vehicles, wherein when executed, the program causes a computer to:
detect a caution-required state, that is a state requiring caution by the surveillant, based on information indicating a state of at least one of around the vehicle and inside the vehicle,
estimate the level of the detected caution-required state based on a level indicating a stage of the caution-required state associated with each of a plurality of caution-required states, and
determine, as a surveillants corresponding to the detected caution-required state, a surveillants having an ability corresponding to the estimated level of the caution-required state, based on a correspondence relationship between the level of caution-required state and the ability of the one or more surveillants.

### REFERENCE SIGNS LIST

1 monitoring system
10 management device
11 processor
12 communication interface
13 storage device
20a operation terminal
20b operation terminal
30a vehicle
30b vehicle
30c vehicle
31 photographing device
32 vehicle control device
40 network
100 program
101 caution-required state detection unit
102 level estimation unit
103 surveillant determination unit
104 notification unit

What is claimed is:

1. A monitoring system for one or more surveillants to monitor one or more vehicles, the monitoring system comprising:
at least one memory storing instructions; and
at least one processor executing:
a caution-required state detection process for detecting a caution-required state, that is a state requiring caution by the surveillant, based on information indicating a state of at least one of around the vehicle and inside the vehicle;
a level estimation process for estimating a level of the detected caution-required state based on a level indicating a stage of a caution-required state associated with each of a plurality of caution-required states; and
a surveillants determination process for determining, as a surveillants corresponding to the detected caution-required state, a surveillants having an ability corresponding to the estimated level of the caution-required state, based on a correspondence relationship between the level of the caution-required state and an ability of the one or more surveillants.

2. The monitoring system according to claim 1, wherein the level of the caution-required state includes a level at which the surveillant does not require a driving control of the vehicle by a remote operation and a level at which the surveillant requires a driving control of the vehicle by a remote operation.

3. The monitoring system according to claim 2, wherein the level requiring the driving control of the vehicle includes a level at which remote control is required for some of the driving tasks in the vehicle and a level at which remote control is required for all the driving tasks in the vehicle.

4. The monitoring system according to claim 1, wherein the surveillant determination process further comprises determining a surveillants corresponding to the detected caution-required state from among surveillants to whom the driving task is not assigned, based on the surveillant and presence or absence of a driving task assigned to the surveillant.

5. The monitoring system according to claim 1, wherein the surveillant determination process further comprises determining a surveillants corresponding to the detected caution-required state from among surveillants waiting for a driving task, based on the surveillant and a standby state of a driving task of the surveillant.

6. The monitoring system according to claim 5, wherein the surveillant determination process further comprises determining, as the surveillant corresponding to the detected caution-required state, a surveillants whose difference time between a scheduled end time of the driving task and a current time is within a predetermined time based on a surveillants to whom the driving task is assigned, the scheduled end time at which the driving task is scheduled to end, and the current time.

7. The monitoring system according to any claim 1, wherein the level estimation process further comprises estimating a level of caution-required state to be estimated based on history information representing a correspondence relationship between a level of the caution-required state detected in the past and position information associated with the caution-required state and position information associated with the caution-required state to be estimated.

8. The monitoring system according to claim 1, wherein the at least one processor further executes:
a process determination process for determining a process to be executed by a vehicle associated with the detected caution-required state based on the caution-required state and the process to be executed by the vehicle; and
a notification process for notifying information indicating the determined process.

9. (Canceled)

10. A method for one or more surveillants to monitor one or more vehicles, wherein a computer is configured to:
detect a caution-required state, that is a state requiring caution by the surveillant, based on information indicating a state of at least one of around the vehicle and inside the vehicle;
estimate the level of the detected caution-required state based on a level indicating a stage of the caution-required state associated with each of a plurality of caution-required states; and
determine, as a surveillants corresponding to the detected caution-required state, a surveillants having an ability corresponding to the estimated level of the caution-required state, based on a correspondence relationship between the level of caution-required state and the ability of the one or more surveillants.

11. A non-transitory computer recording medium recorded with a program for one or more surveillants to monitor one or more vehicles, wherein when executed, the program causes a computer to:
detect a caution-required state, that is a state requiring caution by the surveillant, based on information indicating a state of at least one of around the vehicle and inside the vehicle;
estimate the level of the detected caution-required state based on a level indicating a stage of the caution-required state associated with each of a plurality of caution-required states; and
determine, as a surveillants corresponding to the detected caution-required state, a surveillants having an ability corresponding to the estimated level of the caution-required state, based on a correspondence relationship between the level of caution-required state and the ability of the one or more surveillants.

12. The monitoring system according to claim 10, wherein the level of the caution-required state includes a level at which the surveillant does not require a driving control of the vehicle by a remote operation and a level at which the surveillant requires a driving control of the vehicle by a remote operation.

13. The method according to claim 12, wherein the level requiring the driving control of the vehicle includes a level at which remote control is required for some of the driving tasks in the vehicle and a level at which remote control is required for all the driving tasks in the vehicle.

14. The method according to claim 10, wherein the computer is configured to determine a surveillants corresponding to the detected caution-required state from among surveillants to whom the driving task is not assigned, based on the surveillant and presence or absence of a driving task assigned to the surveillant.

15. The method according to claim 10, wherein the computer is configured to determine a surveillants corresponding to the detected caution-required state from among surveillants waiting for a driving task, based on the surveillant and a standby state of a driving task of the surveillant.

16. The method according to claim 15, wherein the computer is configured to determine, as the surveillant corresponding to the detected caution-required state, a surveillants whose difference time between a scheduled end time of the driving task and a current time is within a predetermined time based on a surveillants to whom the driving task is assigned, the scheduled end time at which the driving task is scheduled to end, and the current time.

17. The method according to claim 10, wherein the computer is configured to estimate a level of caution-required state to be estimated based on history information representing a correspondence relationship between a level of the caution-required state detected in the past and position information associated with the caution-required state and position information associated with the caution-required state to be estimated.

18. The method according to claim 10, wherein the computer is configured to:
determine a process to be executed by a vehicle associated with the detected caution-required state based on the caution-required state and the process to be executed by the vehicle; and
notify information indicating the determined process.
